(19) United States
(12) Patent Application Publication
(10) Pub. No.: US 2007/0143788 A1
(43) Pub. Date: Jun. 21, 2007

(54) Method, apparatus, and program product for providing local information in a digital video stream

(76) Inventors: Michael Negley Abernethy JR., Pflugerville, TX (US); Kulvir Singh Bhogal, Fort Worth, TX (US); Travis M. Grigsby, Austin, TX (US); Robert Norris-Lance Krentler, Austin, TX (US); Alexandre Polozoff, Bloomington, IL (US)

Correspondence Address: IBM CORP (YA);C/O YEE & ASSOCIATES PC, P.O. BOX 802333, DALLAS, TX, 75380, US

(21) Appl. No.: 11/315,382

(22) Filed: Dec. 21, 2005

(51) Int. Cl. H04N 7/10

(52) U.S. Cl. 725/35

(57) ABSTRACT

Localized information is embedded as metadata within a digital video stream. A television receiver then compares the localized information with preconfigured location information. If a match is found, the television receiver presents the localized information with the video data.

### BACKGROUND OF THE INVENTION

1. Field of the Invention

The present invention relates generally to digital television and, more particularly, to advertising within digital television. Still more particularly, the present invention relates to providing local information in a digital video stream.

2. Description of the Related Art

Currently, advertisers face a conundrum—they want to advertise on a national level by advertising during national television broadcasts; however, they cannot convey any localized information in a national commercial because it is being distributed to a national audience. This presents problems to many industries which rely on national advertising, but are franchised to local markets. Industries that face this problem include fast food chains, car dealerships, department stores, and the like.

The problem to the advertiser is how to keep the information in the commercial general enough for a national audience, but specific enough to provide information for each individual viewer. Currently, this is a very difficult balance that usually leaves the commercial lacking in one respect or the other. Many advertisers have opted instead to stick with the least common denominator and to provide information as broadly as possible.

Some advertisers attempt to work around this problem by attaching a local segment at the end of a commercial. A typical example is to use a normal thirty-two second advertising slot by dividing it into thirty seconds of national, broad information, followed by two seconds of local advertising information. However, this solution has the disadvantage of added cost for creating up to three hundred, or perhaps more, different commercials, which also have limited scope. For instance, the “local” information is typically for a major metropolitan area, which can be as large as hundreds of miles.

As a specific example, a fast food company may show a commercial during a nationally broadcast prime time program. The commercial would present a new sandwich, for example, that is being offered to every store in the country, but would not be able to tell the consumer the address of a nearby restaurant or the hours that restaurant is open. This information is obviously different for each localized subset of the viewership.

### SUMMARY OF THE INVENTION

The present invention recognizes the disadvantages of the prior art and provides a mechanism in a digital video receiver for providing local information in a digital video stream. The digital video receiver receives a digital video stream, wherein the digital video stream has embedded therein a plurality of location information elements and localized information associated with each of the plurality of location information elements. The mechanism retrieves preconfigured location information and determines whether the preconfigured location information matches a given one of the plurality of location information elements. The mechanism then identifies localized information associated with the given one of the plurality of location information elements and presents the identified localized information with the digital video stream.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which exemplary aspects of the present invention may be implemented;

FIGS. 2A and 2B depict a pictorial representation of an example television network environment in which exemplary aspects of the present invention may be implemented;

FIG. 3 is a block diagram illustrating a television system for providing local information in a digital video stream in accordance with exemplary aspects of the present invention;

FIG. 4 illustrates an example of metadata with localized information in accordance with exemplary aspects of the present invention;

FIGS. 5A and 5B illustrate example screens of display with localized information in accordance with exemplary aspects of the present invention;

FIG. 6 is a flowchart illustrating operation of a digital video provider in accordance with exemplary aspects of the present invention; and

FIG. 7 is a flowchart illustrating operation of a digital video receiver in accordance with exemplary aspects of the present invention.

### DETAILED DESCRIPTION OF THE PREFERRED EMBODIMENT

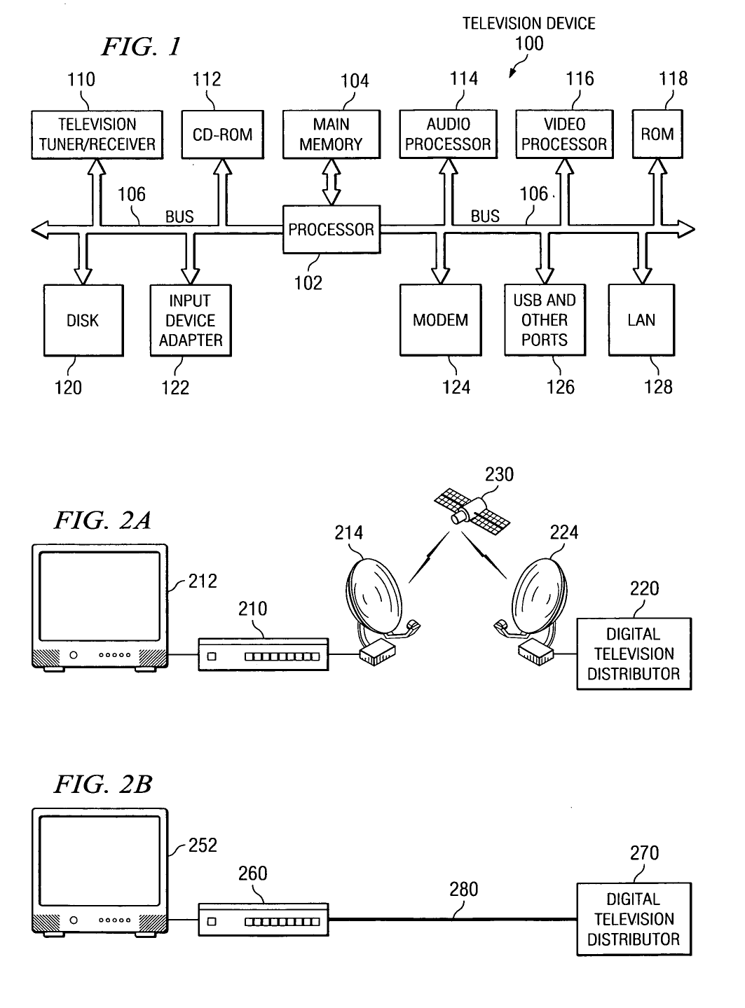

The present invention provides a method, apparatus, and computer program product for providing local information in a digital video stream. The data processing device may be a single-processor computing device, a multiprocessing data processing system, or a virtual processor environment in which multiple processors and multiple layers of software may be utilized to perform various aspects of the present invention. Therefore, the following FIGS. 1 and 2 are provided as exemplary diagrams of data processing environments in which exemplary aspects of the present invention may be implemented. It should be appreciated that FIGS. 1 and 2 are only exemplary and are not intended to assert or imply any limitation with regard to the environments in which the present invention may be implemented. Many modifications to the depicted environments may be made without departing from the spirit and scope of the present invention.

With reference now to FIG. 1, a block diagram of a data processing system is shown in which exemplary aspects of the present invention may be implemented. Television device 100 is an example of a television device, such as a digital video recorder (DVR), cable television receiver, satellite television receiver, or the like, in which code or instructions implementing the processes of the present invention may be located. In the depicted example, television device 100 employs a bus architecture through which processor 102 connects to other components of the device. Main memory 104 is connected to processor 102.

Television tuner/receiver 110 is connected to processor 102 through bus 106. Television tuner/receiver 110 may be, for example, a National Television System Committee (NTSC), Advanced Television Systems Committee (ATSC) over the air (OTA) tuner. Alternatively, television tuner/receiver 110 may be a digital cable or digital satellite receiver. In yet another embodiment, television tuner/receiver 110 may be a television input port that receives an audio/video signal from an external tuner/receiver. Other receivers may also be used in place of television tuner/receiver 110, such as a satellite radio receiver or Internet Protocol television (IP-TV), for example.

Bus 106 also connects audio processor 114, video processor 116, read-only memory (ROM) 118, disk 120, and input device adapter 122 to processor 102. Audio processor 114 may provide audio processing, such as Dolby® Pro Logic® II or Dolby® Digital surround sound decoding. Video processor 116 may perform processing, such as MPEG2 or MPEG4 decoding. Disk 120 may be a hard disk drive (HDD) for storing media content streams. Input device adapter 122 may be, for example, an infrared (IR) remote control receiver, a keyboard/mouse adapter, or the like.

Television device 100 may also include optical disk reader 112, which may be, for example, a compact disk (CD) drive, digital video disk (DVD) drive, or the like. Modem 124 may be used to dial into a server to retrieve program guide information or the like. Universal Serial Bus (USB) and other ports 126 may be connected to processor 102 through bus 106. These ports may allow peripheral devices, such as printers, network adapters, etc., to be connected to television device 100. Local area network adapter 128 may allow television device 100 to share media content to other devices, to acquire program guide data, or to receive content of a program.

An operating system runs on processor 102 and is used to coordinate and provide control of various components within data processing system 100 in FIG. 1. The operating system may be a commercially available operating system such as Linux™, for example. “LINUX” is a trademark of Linus Torvalds. Instructions for the operating system and applications or programs are located on storage devices, such as hard disk drive 120 or ROM 118, and may be loaded into main memory 104 for execution by processor 102. The exemplary aspects of the present invention may be performed by processor 102 using computer implemented instructions, which may be located in a memory such as, for example, main memory 104. Television device 100 may store media streams, including advertising, on disk 120.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. The depicted example in FIG. 1 and above-described examples are not meant to imply architectural limitations. For example, television device 100 also may be a desktop computer, laptop computer, or telephone device in addition to taking the form of a television device.

Many television devices that receive digital television have a preconfigured local zoning improvement plan (ZIP) code or other location information. ZIP Code used to be a registered trademark of the United States Postal Service, but its registration has since expired. As an example, a satellite receiver typically asks for a ZIP code and provides directions to point the satellite dish according to the location of the dish based on the ZIP code. A digital satellite or digital cable receiver may also ask for a ZIP code to retrieve local programming information for the program guide.

In accordance with exemplary aspects of the present invention, television device 100 receives streaming video data with localized information embedded as metadata. Television device 100 examines the metadata and attempts to find a match with a preconfigured local ZIP code. In the metadata, each ZIP code is associated with localized information. If a match is found, the localized information associated with the local ZIP code is presented with the video data.

FIGS. 2A and 2B depict a pictorial representation of an example television network environment in which exemplary aspects of the present invention may be implemented. More particularly, with reference to FIG. 2A, a satellite television network system is illustrated. In the depicted example, television device 210 is connected to television 212. Television device 210 may be television device 100 in FIG. 1, for example. Television device 210 receives streams of audio and video data from satellite dish 214, which, in turn, receives streams of audio and video data from satellite 230. Dish 214 may be connected to tuner/receiver 110 in FIG. 1, for instance. Digital television distributor 220 uplinks the audio and video data to satellite 230 through dish 224.

A television distributor, such as digital television distributor 220, is an entity that provides access to content, such as a cable provider, a satellite provider, or an Internet provider. A television distributor typically receives content from a content provider, such as a television studio, a movie studio, or an advertiser in this case. For example, Home Box Office, Inc. provides content to several satellite television providers and many cable television providers. Similarly, national advertisers may provide a commercial spot to many television distributors to be aired during particular programs.

Turning to FIG. 2B, a digital cable network system is depicted. In the depicted example, television device 260 is connected to television 252. Television device 260 may be television device 100 in FIG. 1, for example. Television device 260 receives streams of audio and video data from digital television distributor 270 via cable 280. Cable 280 may be connected to tuner/receiver 110 in FIG. 1, for instance. For simplicity, a single cable is shown; however, audio and video data is typically provided through a network of cables, switches, and relays.

FIGS. 2A and 2B illustrate digital satellite and digital cable television networks. However, digital television may be broadcast or transmitted through other communications means, such as over-the-air (OTA) transmission, wireless telephone networks, the Internet, etc.

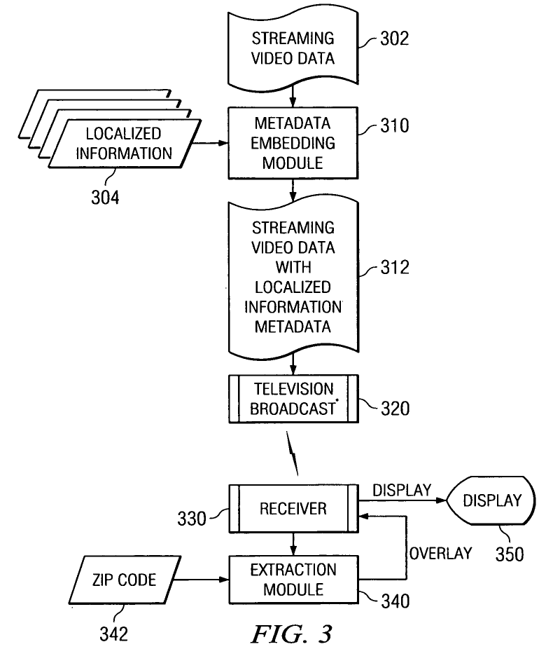

FIG. 3 is a block diagram illustrating a television system for providing local information in a digital video stream in accordance with exemplary aspects of the present invention. Metadata embedding module 310 receives streaming video data 302 and localized information 304. Metadata embedding module embeds localized information 304 into streaming video data 302 as metadata. Resulting streaming video data with localized information metadata 312 is provided to television broadcast 320 to broadcast the television video stream to consumers.

While the depicted example illustrates streaming video data, the streaming data may include audio data in addition to video data. In one alternative embodiment, the streaming data may be audio only. Satellite radio provides audio content. A small screen scrolls text about the audio content, such as artist name, song title, etc. During a commercial, the small screen displays text about the advertiser. In accordance with one exemplary embodiment, the advertiser text may be supplemented with localized information.

Also, the depicted example illustrates television broadcast. However, the streaming video data may be transmitted in other ways, such as on-demand streaming, Internet streaming, and the like.

Components shown in FIG. 3 are functional components that may be implemented as hardware, software, or a combination of hardware and software. For example, receiver 310 may be tuner/receiver 110, software running on processor 102 that receives and decodes the television signal, or a combination of software and hardware elements in FIG. 1. Receiver 330 receives streaming video data with localized information metadata 312. Receiver 330 has stored therein preconfigured ZIP code 342.

Extraction module 340, which may be software running on processor 102 in FIG. 1, for example, extracts the metadata from the video stream and matches the localized information to preconfigured ZIP code 342. Preconfigured ZIP code 342 may be stored on a persistent storage device, such as disk 120 in FIG. 1, for instance. If a match occurs, extraction module presents the localized information with the video data on display 350.

In the depicted example, the localized information is presented by overlaying the localized information onto the video presentation. However, other manners of presenting the localized information may be used. For example, a text-to-speech converter (not shown) may present the localized information as spoken content.

Extraction module 340 may be embodied as software within receiver 330. Alternatively, extraction module 340 may take the form of entirely hardware or a combination of hardware and software elements.

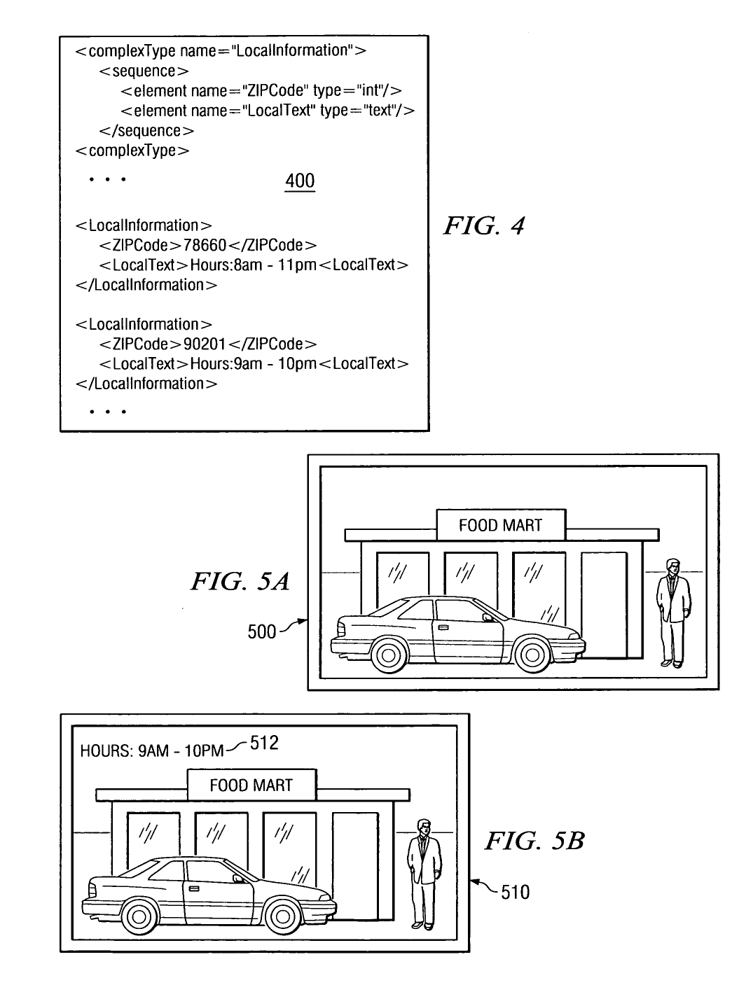

FIG. 4 illustrates an example of metadata with localized information in accordance with exemplary aspects of the present invention. Metadata 400 defines a complex type for local information. Metadata 400 is an example that is based on the extensible markup language (XML).

Each instance of local information has a ZIP code element and a local text element. The definition of localized information may vary depending upon the implementation. For example, local information may include images or sound in addition to or in place of text.

In the depicted example, a first instance of local information has a ZIP code of “78660.” The local text associated with this ZIP code is “Hours:8 am-11 pm.” A second instance defines a ZIP code of “90201” and local text as “Hours:9 am-10 pm.” The depicted metadata is meant as an example only and is not meant to imply limitations on the format or content of the localized information metadata. For instance, the local text element may be associated with a list or range of ZIP codes.

FIGS. 5A and 5B illustrate example screens of display with localized information in accordance with exemplary aspects of the present invention. More particularly, FIG. 5A illustrates a screen layout 500 with a commercial having no localized information presented. As an example, screen layout 500 may be displayed when the video data does not have embedded localized information metadata, the receiver does not have a preconfigured ZIP code, or the preconfigured ZIP code does not match any localized information embedded in the video stream.

FIG. 5B illustrates screen layout 510 with a commercial having localized information presented. In this example, the receiver has a preconfigured ZIP code and the preconfigured ZIP code is matched with localized information embedded within the video stream. The localized information is extracted and overlaid as text 512 on screen layout 510.

While the depicted examples illustrate a commercial with localized information, the video stream may be for other purposes. For example, a national morning news program may show a national weather forecast. In this case, the localized information may present local forecast information or instructions on how to obtain a local weather forecast, such as by providing a World Wide Web address for that forecast. As a further example, a music video channel may provide localized information about local retailers that sell compact discs for the currently playing artist.

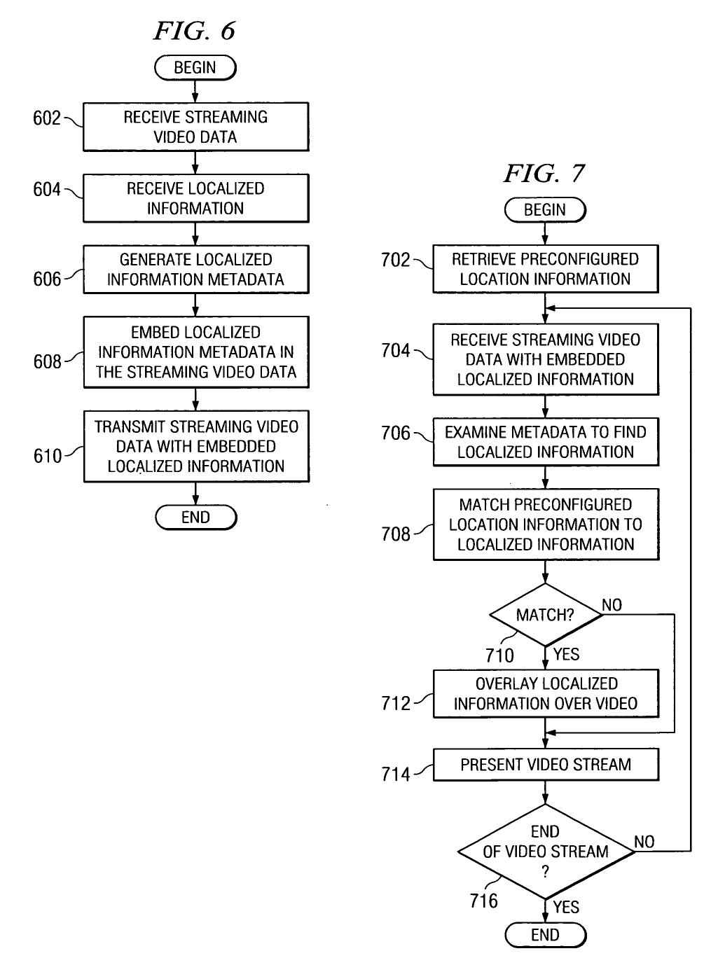

FIG. 6 is a flowchart illustrating operation of a digital video provider in accordance with exemplary aspects of the present invention. FIG. 7 is a flowchart illustrating operation of a digital video receiver in accordance with exemplary aspects of the present invention. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks.

These computer program instructions may also be stored in a computer-readable memory, transmission medium, or storage medium that can direct a processor or other programmable data processing apparatus to function in a particular manner, such that the instructions stored in the computer-readable memory, transmission medium, or storage medium produce an article of manufacture including instruction means which implement the functions specified in the flowchart block or blocks.

Accordingly, blocks of the flowchart illustrations support combinations of means for performing the specified functions, combinations of steps for performing the specified functions and computer usable program code for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

With particular reference to FIG. 6, operation of a digital video provider is illustrated. Operation begins and the digital video provider receives streaming video data (block 602) and receives localized information (604). The localized information may be initially stored in a database or text file, for example. Alternatively, the advertiser may embed the digital localized information in the metadata header of a commercial.

The digital video provider then generates localized information metadata for the video stream (block 606). Next, the digital video provider embeds the localized information metadata in the streaming video data (block 608). Thereafter, the digital video provider transmits the streaming video data with embedded localized information to consumers (block 610), and operation ends.

Turning to FIG. 7, the operation of a digital video receiver is illustrated. Operation begins and the digital video receiver retrieves preconfigured location information (block 702). As discussed above, the preconfigured location information may be a ZIP code, for example. Other examples of location information may include a street address, global positioning system (GPS) coordinates received from a GPS device, a range of GPS coordinates, and the like. The digital video receiver then receives streaming video data with embedded localized information (block 704).

Next, the digital video receiver examines the metadata embedded in the video stream to find localized information (block 706). The receiver then attempts to match the preconfigured location information to the localized information embedded in the video stream (block 708). The receiver determines whether a match is found (block 710).

If a match is found, the digital video receiver overlays the localized information over the video data (block 712) and presents the video stream (block 714). If a match is not found in block 710, operation proceeds to block 714 to present the video stream. In another embodiment, the localized information is merged with the content stream. For example, if the localized information is presented as audio, the localized audio may be merged with the content stream.

After presenting the video data in block 714, the digital video receiver determines whether the end of the video stream is reached (block 716). If the end of the video stream is not reached, operation returns to block 704 to receive the streaming video data with embedded localized information. Otherwise, if the end of the video stream is reached in block 716, operation ends.

Thus, the aspects of the present invention solve the disadvantages of the prior art by providing localized information embedded as metadata within a digital video stream. A television receiver then compares the localized information with preconfigured location information. If a match is found, the television receiver presents the localized information with the video data.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a digital video receiver, the method comprising:
retrieving preconfigured location information;
receiving a digital video stream, wherein the digital video stream has embedded therein at least one location information element and localized information associated with each of the at least one location information element;
determining whether the preconfigured location information matches a given one of the at least one location information element;
identifying localized information associated with the given one of the at least one location information element; and
presenting the identified localized information with the digital video stream.

2. The method of claim 1, wherein preconfigured location information comprises a zoning improvement plan (ZIP) code or global positioning system (GPS) location coordinates.

3. The method of claim 1, wherein a given location information element within the at least one location information elements comprises a ZIP code, a list of ZIP codes, a range of ZIP codes, GPS location coordinates, or a range of GPS location coordinates.

4. The method of claim 1, wherein presenting the identified localized information with the digital video stream comprises:
overlaying the localized information over the digital video stream or merging the localized information with the digital video stream.

5. The method of claim 1, wherein the at least one location information element and associated localized information are embedded in the digital video stream as metadata.

6. The method of claim 1, wherein the digital video stream comprises an advertisement.

7. The method of claim 1, wherein the digital video stream is a television broadcast.

8. The method of claim 1, wherein receiving the digital video stream comprises streaming the digital video stream over the Internet.

9. An apparatus, comprising:
a digital video receiver that receives a digital video stream, wherein the digital video stream has embedded therein at least one location information element and localized information associated with each of the at least one location information element;
an extraction module that retrieves preconfigured location information, determines whether the preconfigured location information matches a given one of the at least one location information element, and identifies localized information associated with the given one of the at least one location information element; and
a presentation component that presents the identified localized information with the digital video stream.

10. The apparatus of claim 9, wherein preconfigured location information comprises a ZIP code or GPS location coordinates.

11. The apparatus of claim 9, wherein a given location information element within the plurality of location information elements comprises a ZIP code, a list of ZIP codes, a range of ZIP codes, GPS location coordinates, or a range of GPS location coordinates.

12. The apparatus of claim 9, wherein the presentation component overlays the localized information over the digital video stream or merges the localized information with the digital video stream.

13. The apparatus of claim 9, wherein the at least one location information element and associated localized information are embedded in the digital video stream as metadata.

14. The apparatus of claim 9, wherein the digital video stream is a television broadcast.

15. The apparatus of claim 9, wherein receiving the digital video stream comprises streaming the digital video stream over the Internet.

16. A computer program product in a digital video receiver, the computer program product comprising:
a computer usable medium having computer usable program code embodied therein;
computer usable program code configured to retrieve preconfigured location information;
computer usable program code configured to receive a digital video stream, wherein the digital video stream has embedded therein at least one location information element and localized information associated with each of the at least one location information element;
computer usable program code configured to determine whether the preconfigured location information matches a given one of the at least one location information element;
computer usable program code configured to identify localized information associated with the given one of the at least one location information element; and
computer usable program code configured to present the identified localized information with the digital video stream.

17. The computer program product of claim 16, wherein preconfigured location information comprises a zoning improvement plan (ZIP) code or GPS location coordinates.

18. The computer program product of claim 16, wherein a given location information element within the plurality of location information elements comprises a ZIP code, a list of ZIP codes, a range of ZIP codes, GPS location coordinates, or a range of GPS location coordinates.

19. The computer program product of claim 16, wherein the computer usable program code configured to present the identified localized information with the digital video stream comprises:
computer usable program code configured to overlay the localized information over the digital video stream or merge the localized information with the digital video stream.

20. The computer program product of claim 16, wherein the at least one location information element and associated localized information are embedded in the digital video stream as metadata.
